(19) United States
(12) Patent Application Publication
(10) Pub. No.: US 2010/0225958 A1
(43) Pub. Date: Sep. 9, 2010

(54) Approach For Printing To Web Services-Enabled Printing Devices

(76) Inventors: Senthil K. Selvaraj, Snoqualmie, WA (US); Zhenning Xiao, Renton, WA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/399,884

(22) Filed: Mar. 6, 2009

(51) Int. Cl. G06F 3/12; G06F 3/048

(52) U.S. Cl. 358/1.15; 715/764

(57) ABSTRACT

According to an approach for printing to Web services-enabled printing devices, a print driver retrieves printing device capabilities data from a Web services-enable printing device and generates printer description data based at least upon the printing device capabilities data. The printer description data specifies display data for one or more features and options currently supported by the Web services-enabled printing device. The print driver generates Graphical User Interface (GUI) data based at least upon the printer description data and provides the GUI data to an application program. The print driver receives application data generated by the application program and generates print data and a print job ticket. The print driver may use the printer description data to generate the print data or the print job ticket. The print driver causes the print data and the print job ticket to be transmitted to the Web services-enabled printing device for processing.

### RELATED APPLICATION DATA

This application is related to U.S. patent application Ser. No. ______ (Attorney Docket No. 49986-0685) entitled “Driverless Architecture For Printing Systems”, filed Mar. 6, 2009, U.S. patent application Ser. No. ______ (Attorney Docket No. 49986-0697) entitled “Paper Size Support For A Print System”, filed Mar. 6, 2009, and U.S. patent application Ser. No. ______ (Attorney Docket No. 49986-0699) entitled “Print Driver Localization Support From Printing Device To Support Multiple User Profiles”, filed Mar. 6, 2009, U.S. patent application Ser. No. 11/846,884 (Attorney Docket No. 49986-0648) entitled “Capability-Based Control Of A Computer Peripheral Device”, filed Aug. 29, 2007, U.S. patent application Ser. No. 11/846,926 (Attorney Docket No. 49986-0649) entitled “Automatically Generating Capability-Based Computer Peripheral Device Drivers”, filed Aug. 29, 2007, U.S. patent application Ser. No. 12/019,610 (Attorney Docket No. 49986-0661) entitled “On-Demand Print Driver”, filed Jan. 24, 2008, U.S. patent application Ser. No. 12/253,823 (Attorney Docket No. 49986-0669) entitled “Providing Device Defined User Interface Modifiers To A Computer System”, filed Oct. 17, 2008, and U.S. patent application Ser. No. 12/360,794 (Attorney Docket No. 49986-0679) entitled “Automatically Updating A Printer Driver With New Printing Device Features”, filed Jan. 27, 2009, the contents all of which are incorporated by reference in their entirety for all purposes as if fully set forth herein.

### FIELD OF THE INVENTION

The present invention relates generally to printing systems and printing to Web services-enabled printing devices.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

When a user wishes to print an electronic document on a printing device, a print subsystem on the user's client device processes application data generated by an application program and generates print data. The print data includes all the information required by the printing device to print the electronic document. For example, a user creates an electronic document using a word processing application on a PC. The user then selects a print option in the word processing application to request that the electronic document be printed to a particular printer. The print subsystem on the PC processes this request by processing the application data generated by the word processing application to generate print data in a format supported by the particular printer, and sends the print data to the particular printer. Generally, print data is sent to a printing device as part of a print job that is recognized by the printing device.

Generating print data conventionally involves the use of a print driver that is specific to the target printing device. That is, each print driver converts print data into a format supported by the target printing device. Therefore, in order for a client device to correctly print to a particular printing device, the client device must have installed on it the print driver for the particular printing device. One of the problems with this approach is that the print driver must be current for the target printing device. If the configuration of a printing device changes, then a new print driver must be generated and distributed to a large number of users. Printing device manufacturers attempt to provide current print drivers available on their Website for download, but many users do not know to check a manufacturer's Website for current drivers. Furthermore, many print drivers must be certified by the company that makes the operating system or by printing device manufactures, which can be time consuming and expensive. Any changes to a print driver typically trigger a re-certification requirement.

### SUMMARY

An approach is provided for printing to Web services-enabled printing devices. A print driver is installed on a client device and allows printing to multiple Web services-enabled printing devices. The print driver is configured to retrieve printing device capabilities data from a Web services-enable printing device, e.g., using WSD communication protocols. The printing device capabilities data specifies a plurality of features and options currently supported by the Web services-enabled printing device. The print driver is further configured to generate printer description data based at least upon the printing device capabilities data. Printer description data specifies display data for one or more feature and options currently supported by the Web services-enabled printing device. The print driver generates graphical user interface data based at least upon the printer description data. When processed by an application program, the graphical user interface data causes the features and options to be displayed on a graphical user interface. The print driver receives application data generated by an application program and generates print data and a print job ticket based at least upon the application data. The print driver may use the printer description data to generate the print data or the print job ticket. The print driver causes the print data and the print job ticket to be transmitted to the Web services-enabled printing device for processing. Embodiments of the invention also include the print driver subscribing to receive events from the Web services-enabled printing device that indicate when a change has occurred to the installed features and options. The print driver is configured to, in response to such an event, update the printer description data.

According to one aspect of the invention, a computer-implemented method for printing to a Web services-enabled printing device includes a print driver executing on a client device and retrieving, from the Web services-enabled printing device, printing device capabilities data that specifies a plurality of features and options currently supported by the Web services-enabled printing device. The print driver generates, based at least upon the printing device capabilities data, printer description data that specifies display data for one or more features and options from the plurality of features and options. The print driver generates, based at least upon the display data contained in the printer description data, graphical user interface data which, when processed by an application program, causes at least a portion of the features and options to be displayed on a graphical user interface. The print driver receives, from the application program, application data generated by the application program. The print driver generates, based at least upon the application data, print data and a print job ticket and causes the print data and the print job ticket to be transmitted to the Web services-enabled printing device.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that depicts an approach for printing to a Web services-enabled printing device.

FIG. 2 is a block diagram that depicts an example printing arrangement that includes a client device and a printing device communicatively coupled via a network.

FIG. 3 is a flow diagram that depicts an approach for printing to a WSD printing device when the client device operating system does not support compatible device IDs.

FIG. 4 is a flow diagram that depicts an approach for printing to a WSD printing device when the client device operating system does support compatible device IDs.

FIG. 5 is a flow diagram depicting an approach for generating printer description data.

FIG. 6 is a flow diagram that depicts an approach for updating printer description data.

FIG. 7 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.
I. OVERVIEW
II. PRINTING SYSTEM ARCHITECTURE
III. PRINTING TO WSD PRINTING DEVICES IN OPERATING SYSTEMS THAT DO NOT SUPPORT COMPATIBLE IDS
IV. PRINTING TO WSD PRINTING DEVICES IN OPERATING SYSTEMS THAT DO SUPPORT COMPATIBLE IDS
V. GENERATING PRINTER DESCRIPTION DATA
VI. DYNAMIC UPDATING OF PRINTER DESCRIPTION DATA
VII. IMPLEMENTATION MECHANISMS
VIII. APPENDIX A—EXAMPLE DEVICE CAPABILITIES DATA
IX. APPENDIX B—EXAMPLE CORE MAPPING DATA
X. APPENDIX C—EXAMPLE PRINTER DESCRIPTION DATA

### I. Overview

An approach is provided for printing to Web services-enabled printing devices. A print driver is installed on a client device and allows printing to multiple Web services-enabled printing devices. The print driver is configured to retrieve printing device capabilities data from a Web services-enable printing device, e.g., using WSD communication protocols. The printing device capabilities data specifies a plurality of features and options currently supported by the Web services-enabled printing device. The print driver is further configured to generate printer description data based at least upon the printing device capabilities data. The printer description data specifies display data for one or more features and options currently supported by the Web services-enabled printing device. The print driver generates graphical user interface data based at least upon the printer description data. When processed by an application program, the graphical user interface data causes the features and options to be displayed on a graphical user interface. The print driver receives application data generated by an application program and generates print data and a print job ticket based at least upon the application data. The print driver may use the printer description data to generate the print data or the print job ticket. The print driver causes the print data and the print job ticket to be transmitted to the Web services-enabled printing device for processing. Embodiments of the invention also include the print driver subscribing to receive events from the Web services-enabled printing device that indicate when a change has occurred to the installed features and options. The print driver is configured to, in response to such an event, update the printer description data.

This approach allows the installation of a print driver that supports a minimum set of Web services-enabled printing device features and options. The print driver can then customize itself to support the current configuration of multiple Web services-enabled printing devices and can adapt over time to changes made to the configuration of those Web services-enabled printing devices.

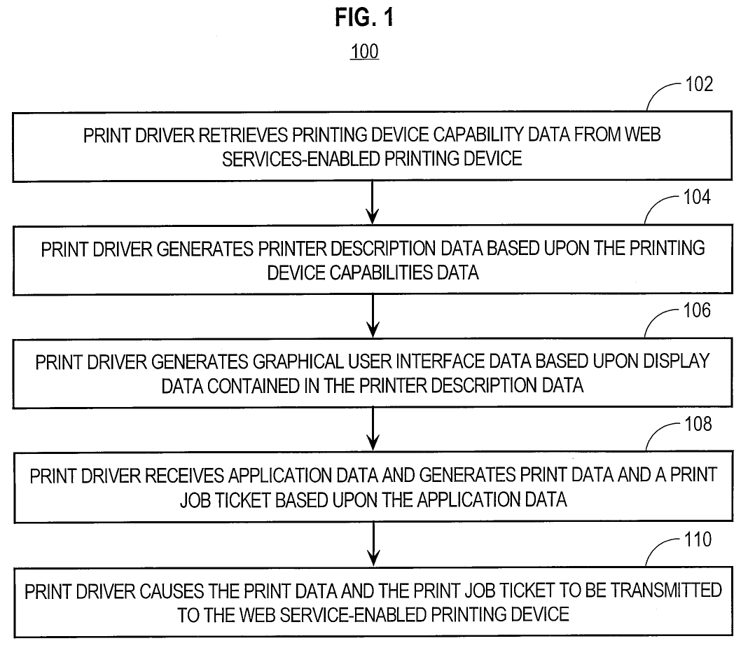

FIG. 1 is a flow diagram that depicts an approach for printing to a Web services-enabled printing device, according to one embodiment of the invention. In step 102, a print driver that is installed and executing on a client device retrieves printing device capabilities data from a Web services-enabled printing device. The printing device capabilities data specifies a plurality of features and options currently supported by the Web services-enabled printing device.

In step 104, the print driver generates printer description data based at least upon the printing device capabilities data. Printer description data specifies display data for one or more features and options currently supported by the Web services-enabled printing device.

In step 106, the print driver generates graphical user interface data based at least upon the display data contained in the printer description data. When processed by an application program, the graphical user interface data causes at least a portion of the features and options to be displayed on a graphical user interface.

In step 108, the print driver receives application data generated by an application program and generates print data and a print job ticket based at least upon the application data. The print driver may use the printer description data to generate the print data or the print job ticket.

In step 110, the print driver causes the print data and the print job ticket to be transmitted to the Web services-enabled printing device for processing.

### II. Printing System Architecture

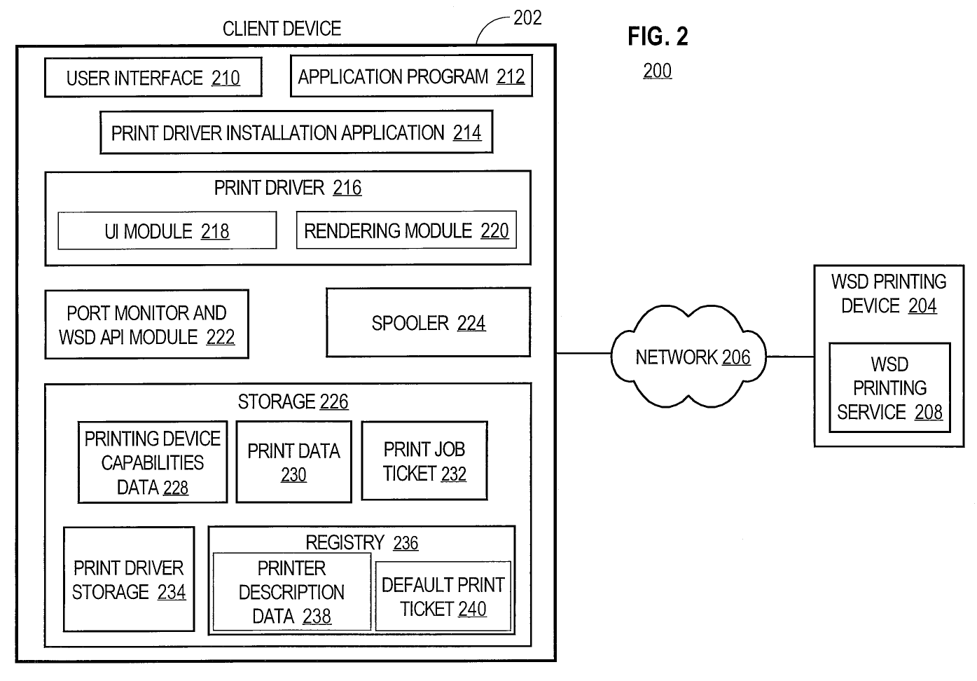

FIG. 2 is a block diagram that depicts an example printing arrangement 200 that includes a client device 202 and a Web Services-enabled (WSD) printing device 204 communicatively coupled via a network 206. Network 206 may be implemented by any medium or mechanism that provides for the exchange of data between client device 202 and WSD printing device 204. Examples of network 206 include, without limitation, a network such as a Local Area Network (LAN), Wide Area Network (WAN), Ethernet or the Internet, or one or more terrestrial, satellite or wireless links.

WSD printing device 204 includes a WSD printing service 208. Client device 202 includes a user interface 210, an application program 212, a print driver installation application 214, a print driver 216, with a User Interface (UI) module and a rendering module 220, a port monitor and Web Services Device (WSD) Application Program Interface (API) module 222, a spooler 224 and a storage 226. Storage 226 stores printing capabilities data 228, print data 230 and a print job ticket 232. Storage also includes a print driver storage 234 and a registry 236 that stores printer description data 238 and a default print ticket 240. Each of these elements is briefly described below and in more detail hereinafter.

User interface 210 is a mechanism and/or medium for presenting information to a user and allowing user input. Application program 212 may be any type of program that prints data. Examples of application program 212 include, without limitation, a word processing program, a spreadsheet program, an email client, etc. A single application program 212 is depicted in FIG. 2 for purposes of explanation, but client device 202 may have any number of application programs.

Printer driver installation application 214 performs installation of print driver 216 which may include installing any data or files required by print driver 216. Installation of print driver 216 may also include obtaining data and/or files from other sources and locations, depending upon an implementation, as well as performing any configuration required by an operating system.

Print driver 216 interacts with application program 212 to generate print data for printing on WSD printing device 204. UI module 218 generates graphical user interface data which, when processed by application program 212, provides a graphical user interface on user interface 210 for a user to select the features and options to be used when printing a particular electronic document. Rendering module 220 processes application data generated by application program 212 and generates print data which, when processed by WSD printing device 204, cause a printed version of an electronic document reflected in the print data to be printed at WSD printing device 204. Print driver 216 performs various other functions that are described in more detail hereinafter.

Port monitor and WSD API module 222 allows communications between print driver 216 and WSD printing device 204. For example, the WSD API module 222 may be installed on a custom port and print driver 216 communicates with the WSD API module 222 via the custom port. The port monitor and WSD API module 222 communicates with WSD printing device 204. Thus, port monitor and WSD API module 222 is capable of converting client side commands, e.g., BiDi function calls, to SOAP requests, in the form of SOAP envelopes, and is also capable of extracting XML information from SOAP responses received from WSD printing device 204, in the form of SOAP envelopes, and generating BiDi function call responses. Port monitor and WSD API module 222 sends SOAP requests to the port associated with WSD printing service 208.

Printing device capabilities data 228 is data that specifies the current features and options, i.e., allowed values for each feature, of WSD printing device 204. Examples of printing device features include, without limitation, a paper tray, duplex printing, stapling, hole punching, ultraviolet (UV) coating, etc. Each feature has one or more options, i.e., values. Some features may only have two options. For example, UV coating typically has two options, such as “enabled” or “disabled”. Other features, for example, paper size, may have many options, e.g., “A4”, “legal”, “8½×11”, etc. Printing device capabilities data 228 stored on client device 202 may include printing device capability data for any number of WSD printing devices.

Print data 230 is data generated by print driver 216, based at least upon application data generated by application program 212, which when processed by WSD printing device 204, causes a printed version of an electronic document represented in the print data 230 to be printed. Print job ticket 232 specifies one or more parameters that indicate how print data 230 is to be processed at WSD printing device 204. Print data 230 may include data for multiple print jobs and print job ticket 232 may include multiple print job tickets.

Printer driver storage 234 contains one or more print drivers that are used by client device to print on printing devices. Registry 236 is an area of storage 226 for storing printer description data 238 and the default print ticket 240. Registry 236 may be a protected area of storage 226 that is under the control of an operating system on client device 202. Default print ticket 240 includes data that indicates default options for the features supported by WSD printing device 204. Default print ticket 240 may include default print tickets for any number of printing devices.

Print driver 216 generates printer description data 238 based at least upon printing device capabilities data 228. Printer description data 238 specifies display data for one or more feature and options currently supported by WSD printing device 204. Print driver 216 uses printer description data 238 to generate graphical user interface data and also for generating print data 230 and/or print job ticket 232.

III. Printing to WSD Printing Devices in Operating Systems that do not Support Compatible IDS

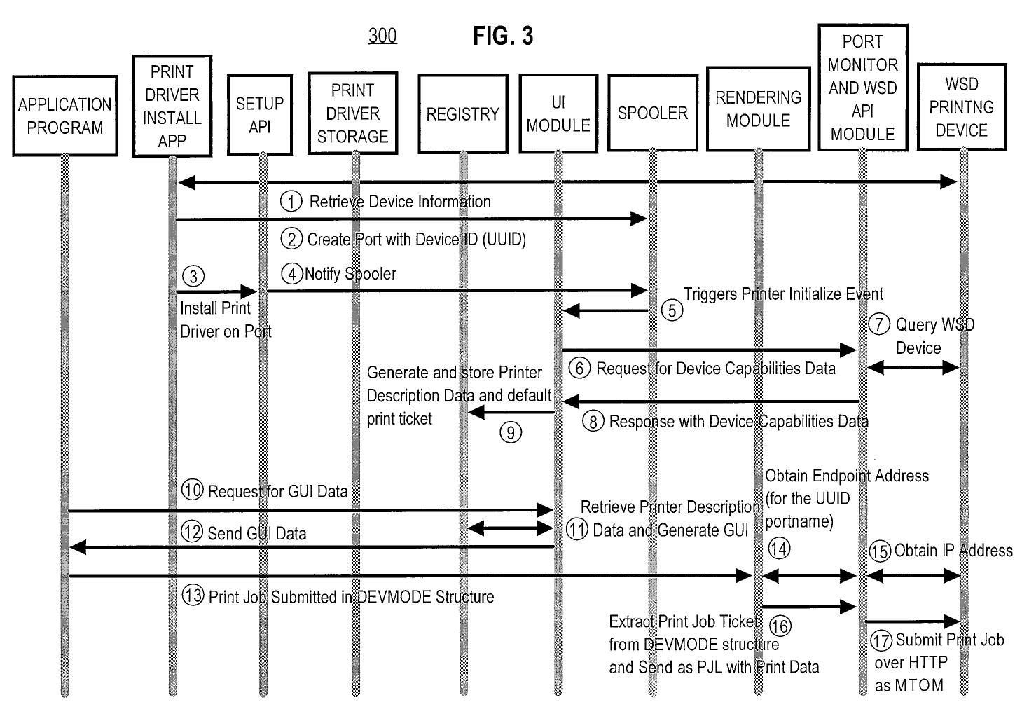

FIG. 3 is a flow diagram 300 that depicts an approach for printing to a WSD printing device when the client device operating system does not support compatible device IDs. One example situation in which this approach may be used is where the operating system on client device 202 does not support the use of a compatible identification. That is, the operating system requires a print driver that matches the target printing device. Examples of these types of operating systems include Windows XP, Windows Vista and other non-Windows operating systems. Typically, the operating system will obtain a device ID of the printing device to be installed and will search for a print driver having the same device ID. For example, in the context of the Windows operating system, the operating system will search for a setup file, known as an INF file, that has a device ID that matches the device ID of the printing device to be installed.

It is presumed that the print driver installation application 214 has discovered the available printing devices and that WSD printing device 204 has been selected for installation. Print driver installation application 214 installs a basic print driver with a basic Generic Printer Description (GPD) file that contains the information necessary, for a standard set of minimum features, to generate a graphical user interface and to generate print data.

In Step 1, print driver installation application 214 retrieves device information from WSD printing device 204, for example, using a unicast request for the metadata of WSD printing device 204. The device information may include, for example, a model number of WSD printing device 204. In Step 2, a port is created using the UUID of WSD printing device 204. In Step 3, print driver installation application 214 installs the print driver on the created port by interacting with a setup API. In Step 4, the setup API notifies spooler 224, which in Step 5 triggers a printer initialization event. For example, this printer initialize event may have an event code of PRINTER_EVENT_INITIALIZE.

In Step 6, UI module 218 responds to the printer initialization event by sending to the port monitor and WSD API module 222 a request for the device capabilities of WSD printing device 204. The request may be implemented, for example, by a call to a SendRecvBiDiData function that contains a request for the device capabilities data of WSD printing device 204. In this situation, the SendRecvBiDiData function makes a call to port monitor and WSD API module 222.

In Step 7, the port monitor and WSD API module 222 receives from UI module 218 the request for the device capabilities data of WSD printing device 204. Port monitor and WSD API module 222 generates a SOAP request, in the form of a SOAP envelope, based at least upon the request received from UI module 218 and forwards the SOAP request to WSD printing device 204. WSD printing device 204 generates and sends to port monitor and WSD API module 222 a SOAP response, in the form of a SOAP envelope, that includes the device capabilities data for WSD printing device 204. The device capabilities data for WSD printing device 204 specifies the features and options currently supported by WSD printing device 204. The device capabilities data in the SOAP response may include any portion or all of the device capabilities data available on WSD printing device 204, depending upon a particular implementation. In addition, the device capability data may be retrieved using any number of SOAP requests and responses. The SOAP response may also include a default print ticket that specifies default options for WSD printing device 204.

In Step 8, port monitor and WSD API module 222 sends to UI module 218 a response that contains the device capabilities data of WSD printing device 204. This may include port monitor and WSD API module 222 extracting XML information from the SOAP response and generating a response that includes the extracted information. In the situation where the request was implemented using a call to SendRecvBiDiData function, the response to the function call contains the device capabilities data from WSD printing device 204.

In Step 9, UI module 218 generates printer description data 238 for WSD printing device 204 and stores printer description data 238 in registry 236. The process for generating printer description data 238 is described in more detail hereinafter. Printer description data 238 and default print ticket 240 are stored in registry 236.

In Step 10, application program 212 makes a request to UI module 218 for Graphical User Interface (GUI) data. In Step 11, UI module 218 retrieves printer description data 238 from registry 236 and generates GUI data based upon printer description data 238. This may include, for example, obtaining strings that correspond to string variables contained in printer description data 238. As described in more detail hereinafter, the string variables are retrieved from a core mapping file (identified therein by rcNameID Value tags) and added to printer description data 238. Strings for the string variables are retrieved from one or more data files that may be maintained, for example, to support different languages, and included in the GUI data. For example, the one or more data files may contain a list of the string variables and corresponding strings that display a feature name or an option name in a particular language. To change the GUI to another language, the one or more data files are substituted with one or more other data files that contain the list of the string variables and corresponding strings that display a feature name or an option name in another language.

The GUI data includes data which, when processed by application program 212, allows a user to view and change the features and settings supported by WSD printing device 204. The GUI data may include, for example, display data that includes display strings that correspond to features and options currently supported by WSD printing device 204. In Step 12, UI module 218 provides the GUI data to application program 212.

A user interacts with application program 212 to view and select particular features and options to be used for printing a particular electronic document. For example, the user may select duplex, color printing with hole punching. Once the user has selected various options elected to print the particular electronic document, in Step 13, application program 212 generates and provides to rendering module 220 a print job with a device mode (DEVMODE) structure that has a single string variable that holds the print job ticket that specifies the job settings. In Step 14, rendering module sends to port monitor and WSD API module 222 a BiDi request for the endpoint address of the device with the port name of the UUID, which in the present example is WSD printing device 204. In Step 15, port monitor and WSD API module 222 generates and sends to WSD printing device 204 a request for the IP address of WSD printing device 204. WSD printing device 204 provides its IP address to port monitor and WSD API module 222, which provides the IP address to rendering module 220.

In Step 16, rendering module 220 extracts the print job ticket from the DEVMODE structure and sends the print job ticket as one or more Printer Job Language (PJL) commands to port monitor and WSD API module 222 with print data 230. The PJL commands may be included as part of print data 230, or sent separately. In Step 17, port monitor and WSD API module 222 submits the print job, including print data 230 and print job ticket 232, to WSD printing device 204 over HTTP. The print data 230 and print job ticket 232 may be sent to WSD printing device 204 using the W3C Message Transmission Optimization Mechanism (MTOM).

IV. Printing to WSD Printing Devices in Operating Systems that do Support Compatible IDS

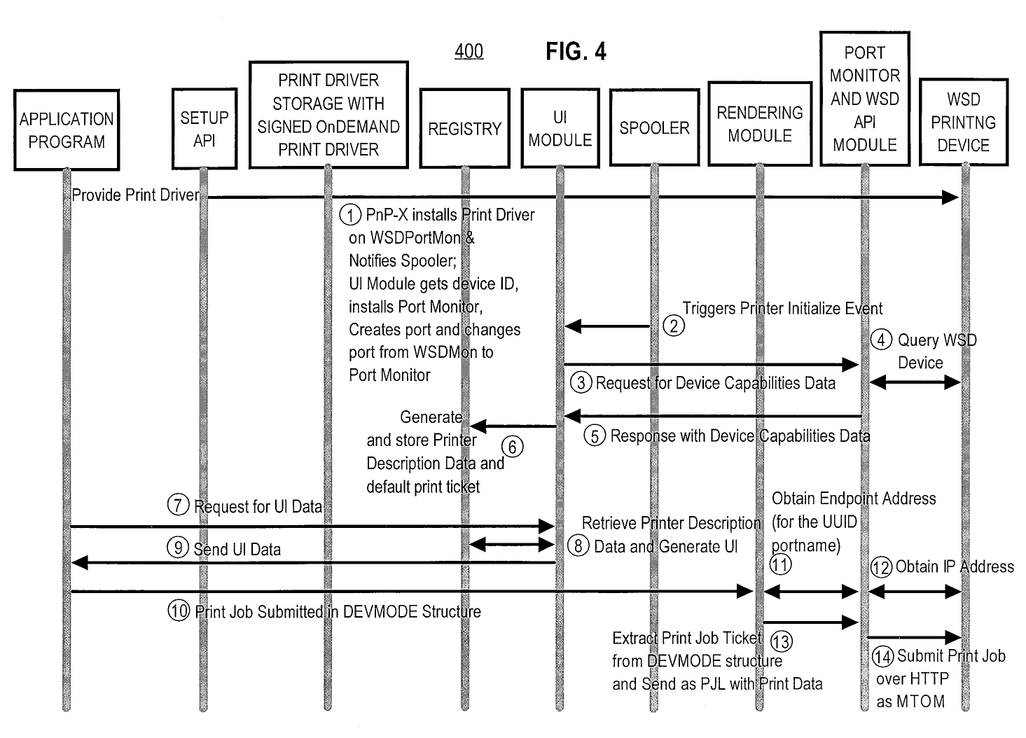

FIG. 4 is a flow diagram 400 that depicts an approach for printing to a WSD printing device when the client device operating system does support compatible device IDs. In this example, the operating system on client device 202 supports the use of compatible IDs. This means that the operating system will search for a setup file that exactly matches the printing device to be installed. If an exact match is not found, the operating system will attempt to locate a setup file for the class, type or group of printing device to be installed. An example of this type of operating system is Windows 7.

In this example, it is presumed that the setup API has provided the print driver on client device 202. In Step 1, a plug and play (PnP-X) function installs the print driver on the standard WSD port monitor and notifies spooler 224. UI module 218 obtains the device ID of WSD printing device 204, installs port monitor and WSD API module 222, creates the port and changes the port from the standard WSD monitor port to the port of port monitor and WSD API module 222. The setup API notifies spooler 224, which in Step 2 triggers a printer initialization event. For example, this printer initialize event may have an event code of PRINTER_EVENT_INITIALIZE.

In Step 3, UI module 218 responds to the printer initialization event by sending to the port monitor and WSD API module 222 a request for the device capabilities of WSD printing device 204. The request may be implemented, for example, by a call to a SendRecvBiDiData function that contains a request for the device capabilities data of WSD printing device 204. In this situation, the SendRecvBiDiData function makes a call to port monitor and WSD API module 222.

In Step 4, the port monitor and WSD API module 222 receives from UI module 218 the request for the device capabilities data of WSD printing device 204. Port monitor and WSD API module 222 generates a SOAP request, in the form of a SOAP envelope, based at least upon the request received from UI module 218 and forwards the SOAP request to WSD printing device 204. WSD printing device 204 generates and sends to port monitor and WSD API module 222 a SOAP response, in the form of a SOAP envelope, that includes the device capabilities data for WSD printing device 204. The device capabilities data for WSD printing device 204 specifies the features and options currently supported by WSD printing device 204. The device capabilities data in the SOAP response may include any portion or all of the device capabilities data available on WSD printing device 204, depending upon a particular implementation. In addition, the device capability data may be retrieved using any number of SOAP requests and responses. The SOAP response may also include a default print ticket that specifies default options for WSD printing device 204.

In Step 5, port monitor and WSD API module 222 sends to UI module 218 a response that contains the device capabilities data of WSD printing device 204. This may include port monitor and WSD API module 222 extracting XML information from the SOAP response and generating a response that includes the extracted information. In the situation where the request was implemented using a call to SendRecvBiDiData function, the response to the function call contains the device capabilities data from WSD printing device 204.

In Step 6, UI module 218 generates printer description data 238 for WSD printing device 204 and stores printer description data 238 in registry 236. The process for generating printer description data 238 is described in more detail hereinafter. Printer description data 238 and default print ticket 240 are stored in registry 236.

In Step 7, application program 212 makes a request to UI module 218 for Graphical User Interface (GUI) data. In Step 8, UI module 218 retrieves printer description data 238 from registry 236 and generates GUI data based at least upon printer description data 238. This may include, for example, obtaining strings that correspond to string variables contained in printer description data 238. The strings may be retrieved from one or more data files that may be maintained, for example, to support different languages. The GUI data includes data which, when processed by application program 212, allows a user to view and change the features and settings supported by WSD printing device 204. The GUI data may include, for example, display data that includes display strings that correspond to features and options currently supported by WSD printing device 204. In Step 9, UI module 218 provides the GUI data to application program 212.

A user interacts with application program 212 to view and select particular features and options to be used for printing a particular electronic document. For example, the user may select duplex, color printing with hole punching. Once the user has selected various options elected to print the particular electronic document, in Step 10, application program 212 generates and provides to rendering module 220 a print job with a device mode (DEVMODE) structure that has a single string variable that holds the print job ticket that specifies the job settings. In Step 11, rendering module sends to port monitor and WSD API module 222 a BiDi request for the endpoint address of the device with the port name of the UUID, which in the present example is WSD printing device 204. In Step 12, port monitor and WSD API module 222 generates and sends to WSD printing device 204 a request for the IP address of WSD printing device 204. WSD printing device 204 provides its IP address to port monitor and WSD API module 222, which provides the IP address to rendering module 220.

In Step 13, rendering module 220 extracts the print job ticket from the DEVMODE structure and sends the print job ticket as one or more Printer Job Language (PJL) commands to port monitor and WSD API module 222 with print data 230. The PJL commands may be included as part of print data 230, or sent separately. In Step 14, port monitor and WSD API module 222 submits the print job, including print data 230 and print job ticket 232, to WSD printing device 204 over HTTP. The print data 230 and print job ticket 232 may be sent to WSD printing device 204 using the W3C Message Transmission Optimization Mechanism (MTOM).

### V. Generating Printer Description Data

As previously described herein, UI module 218 is configured to generate and store, in registry 236, printer description data 238 and is also configured to store default print tickets received from WSD printing device 204. Printer description data 238 is used by UI module 218 to generate GUI data which, when processed by application program 212, causes a GUI to be displayed on user interface 210 that displays the features and options supported by WSD printing device 204 and allows a user to select one or more features and options to be used when printing a particular electronic document.

The process for generating printer description data 238 generally involves combining information from the printing device capabilities data 228 for WSD printing device 204 and data from Core Mapping Data that is provided as part of the basic installed print driver. Appendix A includes example printing device capabilities data, Appendix B includes example core mapping data and Appendix C includes example printer description data.

According to one embodiment of the invention, UI module 218 examines the printing device capabilities data 228 and identifies the printing device features specified therein. For each feature in printing device capabilities data 228, UI module 218 determines whether the feature is defined in the core mapping data. Core mapping data includes PDLKeywords and rcNameIDs for a standard set of printing device features and options. If a particular feature in printing device capabilities data 228 is defined in the core mapping data, then UI module 218 retrieves a PDLkeyWord value and rcNameID Value for the particular feature and each of the corresponding options from the core mapping file and stores the PDLkeyWord values and the rcNameID Values in printer description data 238. The PDLkeyWord value provides a mapping between a feature or option terminology understood by print driver 216 and the terminology understood by WSD printing service 208 for the same feature or option. The rcNameID Value indicates the name of a string variable (resource ID) that contains the string for the feature or option. The string is included in the GUI data that is generated by UI module 218 and provided to application program 212. Consider the following example. Suppose that printing device capabilities data 228 includes a feature named “InputTray4”. Suppose further that this feature is defined in the core mapping data as indicated below in Table I.

TABLE I

```
<DeviceFeature Value=“InputTray4”>
  <PDLKeyword Value=“InputTray4”/>
  <rcNameID Value=“RC_STR_TRAY4” />
  <FeatureOption Value=“NotInstalled”>
    <PDLKeyword Value=“NotInstalled” />
    <rcNameID Value=“RC_STR_NOTINSTALLED” />
  </FeatureOption >
  <FeatureOption Value=“Installed”>
    <PDLKeyword Value=“Installed” />
    <rcNameID Value=“RC_STR_INSTALLED” />
  </FeatureOption >
</DeviceFeature >
```

As indicated in Table I, the feature InputTray4 has two options that include “NotInstalled” and “Installed”. Note that the feature and each option has both a specified PDLKeyword value and a specified rcNameID value, which UI module 218 retrieves and stores in printer description data.

If the particular feature in printing device capabilities data 228 is not defined in the core mapping file, then the particular feature is typically a new feature. In this situation, UI module 218 uses the feature name for the particular feature from the printing device capabilities data 228 to generate the PDLkeyWord value for printer description data 238. In addition, UI module 218 includes the DisplayName values for the particular feature in printer description data 238. Multiple DisplayName values may be included in printer description data 238 for each feature and/or option to provide support for multiple languages. The display name values are included in the GUI data that is generated by UI module 218 and provided to application program 212. Referring to the prior example, suppose that the feature named “InputTray4” is not defined in the core mapping data. Suppose further that this feature is defined in printing device capabilities data 228 as indicated below in Table II.

TABLE II

```
<rodp:InputTray4>
      <rodp:DisplayName xml:lang=“en-US”>Tray
      4</rodp:DisplayName>
      <rodp:DefaultOption>NotInstalled</rodp:DefaultOption>
      <rodp:InputTray4Entry Name=“NotInstalled”>
        <rodp:DisplayName xml:lang=“en-US”>Not
        Installed</rodp:DisplayName>
      </rodp:InputTray4Entry>
      <rodp:InputTray4Entry Name=“Installed”>
        <rodp:DisplayName xml:lang=“en-US”>Installed
        </rodp:DisplayName>
      </rodp:InputTray4Entry>
    </rodp:InputTray4>
```

As indicated in TABLE II, there are no PDLKeyword values or rcNameID values contained in the definition of the InputTray4 feature in printing device capabilities data 228. In this example, the feature name “InputTray4” is stored in printer description data 238 as the PDLKeyword value. Also, UI module 218 retrieves the DisplayName values for the feature and each option and stores the DisplayName values in printer description data 238.

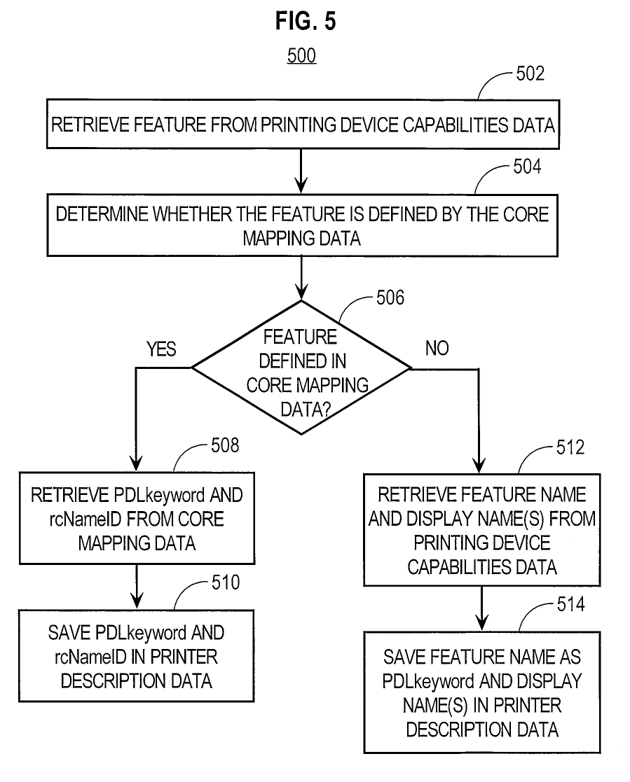

FIG. 5 is a flow diagram 500 depicting an approach for generating printer description data 238 for a particular feature from printing device capabilities data 228, according to one embodiment of the invention. This approach may be used for any number of features and also for any number of options for each feature. In step 502, a feature is retrieved from printing device capabilities data 228. In step 504, a determination is made whether the feature is defined in the core mapping data. In step 506, if the feature is defined in the core mapping data, then in step 508, the PDLkeyword and rcNameID are retrieved from the core mapping data. In step 510, the PDLkeyword and rcNameID are stored in printer description data 238. As previously mention herein, printer description data 238 may include printer description data for any number of WSD printing devices.

If, in step 506, a determination is made that the feature is not defined in the core mapping data, then in step 512, the feature name and display name(s) are retrieved from printing device capabilities data 228. As previously described herein, multiple display names may be used to provide support for multiple languages. In step 514, the feature name is stored in printer description data 238 as the PDLkeyword for the feature. Also, the display name(s) are stored in printer description data 238 in association with the feature.

### VI. Dynamic Updating of Printer Description Data

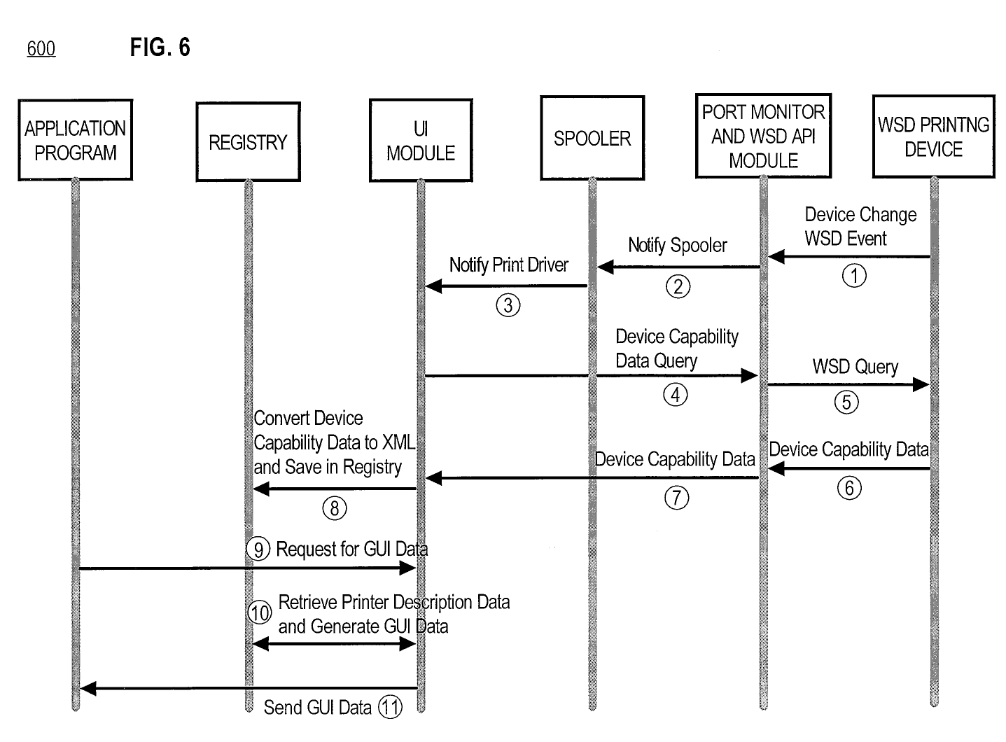

FIG. 6 is a flow diagram that depicts an approach for updating printer description data, according to one embodiment of the invention. In Step 1, WSD printing device 204 generates an event indicating a change in printing features or options. This may include the deletion, addition or change of a printing feature or option. Port monitor and WSD API module 222 has subscribed to receive this event and receives the event. For example, port monitor and WSD API module 222 may receive an event notification in the form of a SOAP message specifying the event.

In Step 2, port monitor and WSD API module 222 receives the event notification and notifies spooler 224. In Step 3, spooler 224 notifies UI module 218. In Step 4, UI module sends to the port monitor and WSD API module 222 a request for the device capabilities of WSD printing device 204. The request may be implemented, for example, by a call to a SendRecvBiDiData function that contains a request for the device capabilities data of WSD printing device 204. In this situation, the SendRecvBiDiData function makes a call to port monitor and WSD API module 222.

In Step 5, the port monitor and WSD API module 222 receives from UI module 218 the request for the device capabilities data of WSD printing device 204. Port monitor and WSD API module 222 generates a SOAP request, in the form of a SOAP envelope, based at least upon the request received from UI module 218 and forwards the SOAP request to WSD printing device 204.

In Step 6, WSD printing device 204 generates and sends to port monitor and WSD API module 222 a SOAP response, in the form of a SOAP envelope, that includes the device capabilities data for WSD printing device 204. The device capabilities data for WSD printing device 204 specifies the features and options currently supported by WSD printing device 204. The device capabilities data in the SOAP response may include any portion or all of the device capabilities data available on WSD printing device 204, depending upon a particular implementation. For example, the device capabilities data retrieved in response to the event notification may include all of the device capabilities data available on WSD printing device 204. Alternatively, only the device capabilities data that corresponds to the change in features or options may be retrieved from WSD printing device 204. In addition, the device capability data may be retrieved using any number of SOAP requests and responses. The SOAP response may also include a default print ticket that specifies default options for WSD printing device 204.

In Step 7, port monitor and WSD API module 222 sends to UI module 218 a response that contains the device capabilities data of WSD printing device 204. This may include port monitor and WSD API module 222 extracting XML information from the SOAP response and generating a response that includes the extracted information. In the situation where the request was implemented using a call to SendRecvBiDiData function, the response to the function call contains the device capabilities data from WSD printing device 204.

In Step 8, UI module 218 generates printer description data 238 for WSD printing device 204 and stores printer description data 238 in registry 236 as previously described herein. Alternatively, UI module 218 may update the existing printer description data for WSD printing device 204 to reflect the change in the features and/or options made to WSD printing device 204.

In Step 9, application program 212 makes a request to UI module 218 for GUI data. In Step 10, UI module 218 retrieves printer description data 238 from registry 236 and generates the requested GUI data. The GUI data includes data which, when processed by application program 212, allows a user to view and change the features and settings supported by WSD printing device 204. The GUI data may include, for example, display data that includes display strings that correspond to features and options currently supported by WSD printing device 204. In Step 11, UI module 218 provides the GUI data to application program 212. The process for processing a print job then continues as previously described in FIGS. 3 and 4.

### VII. Implementation Mechanisms

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

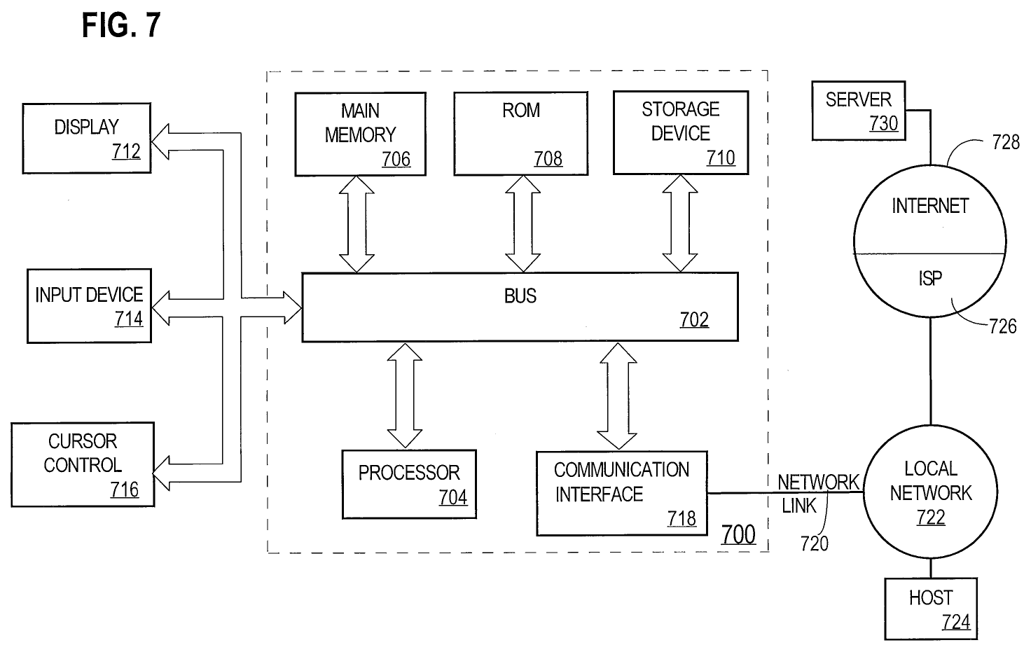

FIG. 7 is a block diagram that depicts an example computer system 700 upon which embodiments of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic or computer software which, in combination with the computer system, causes or programs computer system 700 to be a special-purpose machine. According to one embodiment of the invention, those techniques are performed by computer system 700 in response to processor 704 executing one or more sequences of one or more instructions contained in main memory 706. Such instructions may be read into main memory 706 from another computer-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 700, various computer-readable media are involved, for example, in providing instructions to processor 704 for execution. Such a medium may take many forms, including but not limited to, non-volatile media and volatile media. Non-volatile media includes, for example, optical or magnetic disks, such as storage device 710. Volatile media includes dynamic memory, such as main memory 706. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for printing to a Web services-enabled printing device, comprising:
a print driver executing on a client device and retrieving, from the Web services-enabled printing device, printing device capabilities data that specifies a plurality of features and options currently supported by the Web services-enabled printing device;
the print driver generating, based at least upon the printing device capabilities data, printer description data that specifies display data for one or more features and options from the plurality of features and options;
the print driver generating, based at least upon the display data contained in the printer description data, graphical user interface data which, when processed by an application program, causes at least a portion of the features and options to be displayed on a graphical user interface;
the print driver receiving, from the application program, application data generated by the application program;
the print driver generating, based at least upon the application data, print data and a print job ticket; and
the print driver causing the print data and the print job ticket to be transmitted to the Web services-enabled printing device.

2. The computer-implemented method as recited in claim 1, wherein:
the display data specifies a string variable that corresponds to a particular option, and
generating the graphical user interface data includes retrieving a string that corresponds to the string variable.

3. The computer-implemented method as recited in claim 1, wherein:
the display data specifies a string that corresponds to a particular option, and
the graphical user interface data includes the string that corresponds to the particular option.

4. The computer-implemented method as recited in claim 1, wherein:
the printer description data specifies a PDL keyword value that corresponds to a particular option, and
generating print data includes using the PDL keyword value to generate particular print data for the particular option.

5. The computer-implemented method as recited in claim 1, wherein the print driver generating, based at least upon the printing device capabilities data, printer description data that specifies display data for one or more features and options from the plurality of features and options includes:
for a particular feature from the plurality of features and options currently supported by the Web services-enabled printing device,
determining whether the particular feature is defined by core mapping data that defines a standard set of features and options supported by the Web services-enabled printing device,
if the particular feature is defined by the core mapping data, then
retrieving from the core mapping data both a PDL keyword value and a string variable that correspond to the particular feature, and
including the PDL keyword value and a string variable in the printer description data in association with the particular feature, and
if the particular feature is not defined by the core mapping data, then
retrieving from the device capabilities data both a feature name and one or more display name strings that correspond to the particular feature,
generating a PDL keyword value based at least upon the feature name, and
including the generated PDL keyword value and the one or more display name strings in the printer description data in association with the particular feature.

6. The computer-implemented method as recited in claim 2, further comprising:
the print driver subscribing to an update service executing on the Web services-enabled printing device;
the print driver receiving, from the update service, an event notification indicating that updated printing device capabilities data is available at the Web services-enabled printing device;
in response to the event notification, the print driver retrieving, from the Web services-enabled printing device, updated printing device capabilities data that specifies current features and options currently supported by the Web services-enabled printing device;
the print driver generating, based at least upon the printing device capabilities data, updated printer description data that that specifies display data for one or more options from the plurality of features and options specified by the updated printing device capabilities data;
the print driver generating, based at least upon the display data contained in the updated printer description data, second graphical user interface data which, when processed by an application program, causes at least a portion of the features and options specified by the updated printing device capabilities data to be displayed on a graphical user interface;
the print driver receiving, from the application program, third print data generated by the application program;
the print driver generating, based at least upon the third print data, fourth print data and a print job ticket; and
the print driver causing the fourth print data and the print job ticket to be transmitted to the Web services-enabled printing device.

7. The computer-implemented method as recited in claim 1, further comprising the print driver:
retrieving, from a second Web services-enabled printing device that is different than the Web services-enabled printing device, second printing device capabilities data that specifies a plurality of features and options currently supported by the second Web services-enabled printing device;
the print driver generating, based at least upon the second printing device capabilities data, second printer description data that specifies display data for one or more features and options from the plurality of features and options currently supported by the second Web services-enabled printing device;
the print driver generating, based at least upon the display data contained in the second printer description data, second graphical user interface data which, when processed by the application program, causes at least a portion of the features and options currently supported by the second Web services-enabled printing device to be displayed on the graphical user interface;
the print driver receiving, from the application program, second application data generated by the application program;
the print driver generating, based at least upon the second application data, second print data and a second print job ticket; and
the print driver causing the second print data and the second print job ticket to be transmitted to the second Web services-enabled printing device.

8. A computer-readable medium for printing to a Web services-enabled printing device, the computer-readable medium carrying instructions which, when processed by one or more processors, causes:
a print driver executing on a client device and retrieving, from the Web services-enabled printing device, printing device capabilities data that specifies a plurality of features and options currently supported by the Web services-enabled printing device;
the print driver generating, based at least upon the printing device capabilities data, printer description data that specifies display data for one or more features and options from the plurality of features and options;
the print driver generating, based at least upon the display data contained in the printer description data, graphical user interface data which, when processed by an application program, causes at least a portion of the features and options to be displayed on a graphical user interface;
the print driver receiving, from the application program, application data generated by the application program;
the print driver generating, based at least upon the application data, print data and a print job ticket; and
the print driver causing the print data and the print job ticket to be transmitted to the Web services-enabled printing device.

9. The computer-readable medium as recited in claim 8, wherein:
the display data specifies a string variable that corresponds to a particular option, and
generating the graphical user interface data includes retrieving a string that corresponds to the string variable.

10. The computer-readable medium as recited in claim 8, wherein:
the display data specifies a string that corresponds to a particular option, and
the graphical user interface data includes the string that corresponds to the particular option.

11. The computer-readable medium as recited in claim 8, wherein:
the printer description data specifies a PDL keyword value that corresponds to a particular option, and
generating print data includes using the PDL keyword value to generate particular print data for the particular option.

12. The computer-readable medium as recited in claim 8, wherein the print driver generating, based at least upon the printing device capabilities data, printer description data that specifies display data for one or more features and options from the plurality of features and options includes:
for a particular feature from the plurality of features and options currently supported by the Web services-enabled printing device,
determining whether the particular feature is defined by core mapping data that defines a standard set of features and options supported by the Web services-enabled printing device,
if the particular feature is defined by the core mapping data, then
retrieving from the core mapping data both a PDL keyword value and a string variable that correspond to the particular feature, and
including the PDL keyword value and a string variable in the printer description data in association with the particular feature, and
if the particular feature is not defined by the core mapping data, then retrieving from the device capabilities data both a feature name and one or more display name strings that correspond to the particular feature,
generating a PDL keyword value based at least upon the feature name, and
including the generated PDL keyword value and the one or more display name strings in the printer description data in association with the particular feature.

13. The computer-readable medium as recited in claim 9, further comprising additional instructions which, when processed by the one or more processors, causes:
the print driver subscribing to an update service executing on the Web services-enabled printing device;
the print driver receiving, from the update service, an event notification indicating that updated printing device capabilities data is available at the Web services-enabled printing device;
in response to the event notification, the print driver retrieving, from the Web services-enabled printing device, updated printing device capabilities data that specifies current features and options currently supported by the Web services-enabled printing device;
the print driver generating, based at least upon the printing device capabilities data, updated printer description data that that specifies display data for one or more options from the plurality of features and options specified by the updated printing device capabilities data;
the print driver generating, based at least upon the display data contained in the updated printer description data, second graphical user interface data which, when processed by an application program, causes at least a portion of the features and options specified by the updated printing device capabilities data to be displayed on a graphical user interface;
the print driver receiving, from the application program, third print data generated by the application program;
the print driver generating, based at least upon the third print data, fourth print data and a print job ticket; and
the print driver causing the fourth print data and the print job ticket to be transmitted to the Web services-enabled printing device.

14. The computer-readable medium as recited in claim 8, further comprising additional instructions which, when processed by the one or more processors, causes the print driver to perform:
retrieving, from a second Web services-enabled printing device that is different than the Web services-enabled printing device, second printing device capabilities data that specifies a plurality of features and options currently supported by the second Web services-enabled printing device;
the print driver generating, based at least upon the second printing device capabilities data, second printer description data that specifies display data for one or more features and options from the plurality of features and options currently supported by the second Web services-enabled printing device;
the print driver generating, based at least upon the display data contained in the second printer description data, second graphical user interface data which, when processed by the application program, causes at least a portion of the features and options currently supported by the second Web services-enabled printing device to be displayed on the graphical user interface;
the print driver receiving, from the application program, second application data generated by the application program;
the print driver generating, based at least upon the second application data, second print data and a second print job ticket; and
the print driver causing the second print data and the second print job ticket to be transmitted to the second Web services-enabled printing device.

15. An apparatus for printing to a Web services-enabled printing device, the apparatus comprising a memory storing instructions which, when processed by one or more processors, causes:
a print driver executing on a client device and retrieving, from the Web services-enabled printing device, printing device capabilities data that specifies a plurality of features and options currently supported by the Web services-enabled printing device;
the print driver generating, based at least upon the printing device capabilities data, printer description data that specifies display data for one or more features and options from the plurality of features and options;
the print driver generating, based at least upon the display data contained in the printer description data, graphical user interface data which, when processed by an application program, causes at least a portion of the features and options to be displayed on a graphical user interface;
the print driver receiving, from the application program, application data generated by the application program;
the print driver generating, based at least upon the application data, print data and a print job ticket; and
the print driver causing the print data and the print job ticket to be transmitted to the Web services-enabled printing device.

16. The apparatus as recited in claim 15, wherein:
the display data specifies a string variable that corresponds to a particular option, and
generating the graphical user interface data includes retrieving a string that corresponds to the string variable.

17. The apparatus as recited in claim 15, wherein:
the printer description data specifies a PDL keyword value that corresponds to a particular option, and
generating print data includes using the PDL keyword value to generate particular print data for the particular option.

18. The apparatus as recited in claim 15, wherein the print driver generating, based at least upon the printing device capabilities data, printer description data that specifies display data for one or more features and options from the plurality of features and options includes:
for a particular feature from the plurality of features and options currently supported by the Web services-enabled printing device,
determining whether the particular feature is defined by core mapping data that defines a standard set of features and options supported by the Web services-enabled printing device,
if the particular feature is defined by the core mapping data, then
retrieving from the core mapping data both a PDL keyword value and a string variable that correspond to the particular feature, and
including the PDL keyword value and a string variable in the printer description data in association with the particular feature, and
if the particular feature is not defined by the core mapping data, then
retrieving from the device capabilities data both a feature name and one or more display name strings that correspond to the particular feature,
generating a PDL keyword value based at least upon the feature name, and
including the generated PDL keyword value and the one or more display name strings in the printer description data in association with the particular feature.

19. The apparatus as recited in claim 16, wherein the memory stores additional instructions which, when processed by the one or more processors, causes:
the print driver subscribing to an update service executing on the Web services-enabled printing device;
the print driver receiving, from the update service, an event notification indicating that updated printing device capabilities data is available at the Web services-enabled printing device;
in response to the event notification, the print driver retrieving, from the Web services-enabled printing device, updated printing device capabilities data that specifies current features and options currently supported by the Web services-enabled printing device;
the print driver generating, based at least upon the printing device capabilities data, updated printer description data that that specifies display data for one or more options from the plurality of features and options specified by the updated printing device capabilities data;
the print driver generating, based at least upon the display data contained in the updated printer description data, second graphical user interface data which, when processed by an application program, causes at least a portion of the features and options specified by the updated printing device capabilities data to be displayed on a graphical user interface;
the print driver receiving, from the application program, third print data generated by the application program;
the print driver generating, based at least upon the third print data, fourth print data and a print job ticket; and
the print driver causing the fourth print data and the print job ticket to be transmitted to the Web services-enabled printing device.

20. The apparatus as recited in claim 15, wherein the memory stores additional instructions which, when processed by the one or more processors, causes the print driver to perform:
retrieving, from a second Web services-enabled printing device that is different than the Web services-enabled printing device, second printing device capabilities data that specifies a plurality of features and options currently supported by the second Web services-enabled printing device;
the print driver generating, based at least upon the second printing device capabilities data, second printer description data that specifies display data for one or more features and options from the plurality of features and options currently supported by the second Web services-enabled printing device;
the print driver generating, based at least upon the display data contained in the second printer description data, second graphical user interface data which, when processed by the application program, causes at least a portion of the features and options currently supported by the second Web services-enabled printing device to be displayed on the graphical user interface;
the print driver receiving, from the application program, second application data generated by the application program;
the print driver generating, based at least upon the second application data, second print data and a second print job ticket; and
the print driver causing the second print data and the second print job ticket to be transmitted to the second Web services-enabled printing device.
